(19) United States
(12) Patent Application Publication
(10) Pub. No.: US 2008/0205388 A1
(43) Pub. Date: Aug. 28, 2008

(54) Discovery of network devices logically located between a client and a service

(75) Inventors: Scott Colville, Seattle, WA (US); James Pinkerton, Sammamish, WA (US); Dan Boldo, Bellevue, WA (US); Maxim Stepin, Redmond, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/709,452

(22) Filed: Feb. 22, 2007

(51) Int. Cl. H04L 12/56

(52) U.S. Cl. 370/389

(57) ABSTRACT

Otherwise network-transparent devices that are logically located between a client device and a service device are discovered by sending a probe packet that has a destination address of one of the client or service but that specifies a discovery network port such as a port of the transport layer. The otherwise network-transparent device receives the packet as it is traversing the hops between the client and service. The network-transparent device analyzes the network traffic passing through it to determine whether the destination port is the discovery network port and thereby recognizes the probe packet. The network-transparent device provides a return packet to the device that sent the probe packet, whereby the return packet provides the source address as the network address of the otherwise network-transparent device. A communication session may then be established between the network-transparent device and the device that sent the probe packet such as to provide a service to the data transfer occurring between the client and service.

### BACKGROUND

Computer networks include various devices distributed logically between endpoint client and service devices that are communicating. These various intermediate devices form hops that the data packets traverse as they are propagated through the network(s) until reaching the final destination. Through routing of the data packets, the endpoints are typically unaware of the intermediate devices. The data packet from one endpoint device has a destination of the other endpoint device that is the final destination for the packet, yet intermediate devices that are network-transparent send and receive the data packets in order to deliver it to the destination. These intermediate devices are network-transparent in that the endpoint client and service devices have no awareness of these intermediate devices.

In certain instances, an intermediate device that is network-transparent to the endpoints may need to be discovered for some purpose. For example, one of the endpoint devices or another intermediate device logically between the endpoint devices may need to become aware of the network address of the network-transparent device in order to establish a communication session directly with the network-transparent device. To the extent the network addresses of the intermediate devices are known by administrators, the network-transparent device and any device that needs to communicate with it may be manually configured to establish the communication session between them. However, it is burdensome to manually configure devices including a network-transparent device and any device that needs to establish a communication session with the network-transparent device. Adding to the burden, computer networks are dynamic by nature in that devices are added and removed, addresses are changed, and so forth such that manually configuring devices is further complicated.

### SUMMARY

Embodiments provide for the discovery of intermediate devices including network-transparent devices. A probe packet is sent to a network address of an endpoint device behind the intermediate device, and the probe packet specifies a discovery network port upon which the intermediate device is known to intercept. Upon the intermediate device receiving the probe packet on its way to the destination address, the intermediate device intercepts the probe packet by analyzing the destination port to see if it is the discovery network port. The intermediate device then responds to the source address of the probe packet with the response providing the source address as that of the intermediate device to thereby expose the intermediate device to the device that sent the probe packet.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### DESCRIPTION OF THE DRAWINGS

FIG. 1 shows an example of a network where one or more intermediate devices are logically located between a client device and a service device.

FIG. 2 shows an example of two intermediate network devices logically located between a client device and a service device.

FIGS. 3A-3D show examples of logical operations performed by an intermediate device.

FIG. 4 shows an example of associations maintained by a device in communication with one or more intermediate network devices.

### DETAILED DESCRIPTION

Embodiments provide the ability to discover network devices logically located between client and services devices including network-transparent devices by utilizing probe packets that specify a discovery network port as the destination port and by having the device being discovered analyze incoming packets to determine if the destination port is the discovery network port and thereby determine that the incoming packet is a probe packet so that it is intercepted. The device being discovered may respond with a return packet to reveal the address of the device being discovered to the device that sent the probe packet. The two devices may then establish communications sessions such as to provide a service for the data communications that occur between the client device and service device.

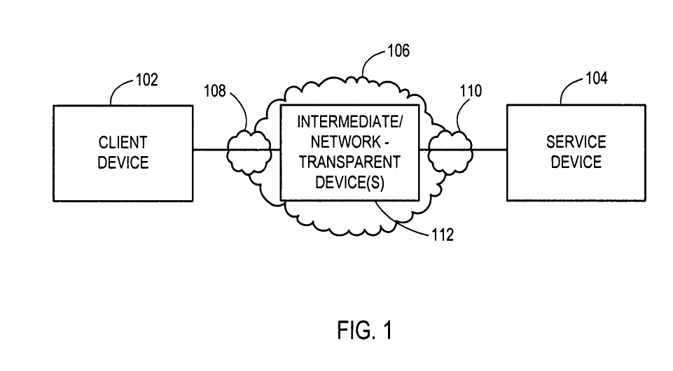

As shown in FIG. 1, a client device 102 and a service device 104 are in communication through one or more networks 106, 108, and 110. For example, the network 108 may be a local area network of the client device 102, while the network 110 may be a local area network of the service device 104. A wide area network 106 may then interconnect the two local area networks 108, 110. Within the networks 106, 108, 110, various intermediate devices 112 may be present. These intermediate devices 112 may be network-transparent in that the client device 102 and service device 104 may not be aware of the intermediate devices 112 even though those intermediate devices 112 are responsible for transferring the data packets of the client and service devices 102, 104.

The intermediate devices 112 may perform one or more various functions to benefit the data communications between the client and service devices 102, 104. For example, the intermediate devices 112 may include switches, routers, or other devices that forward packets in an efficient manner through the networks 106, 108, and 110. However, the intermediate devices 112 may provide more advanced features, such proxy services, authentication services, load balancing services, anti-virus services, anti-spam services, tunneling services including virtual private networking, encryption services, compression services, and so forth.

While FIG. 1 refers to a client device 102 and a service device 104, the role of these devices may be reversed as well. For example, both of these devices 102, 104 may be clients of respective servers or may act as servers for other client devices. Furthermore, in one context, device 102 may be a client of a service of device 104 as shown, while in another context, device 102 may provide a service back to device 104. Thus, the labels applied to such devices in relation to all figures and embodiments discussed herein are intended only for purposes of illustration and are not intended to be limiting.

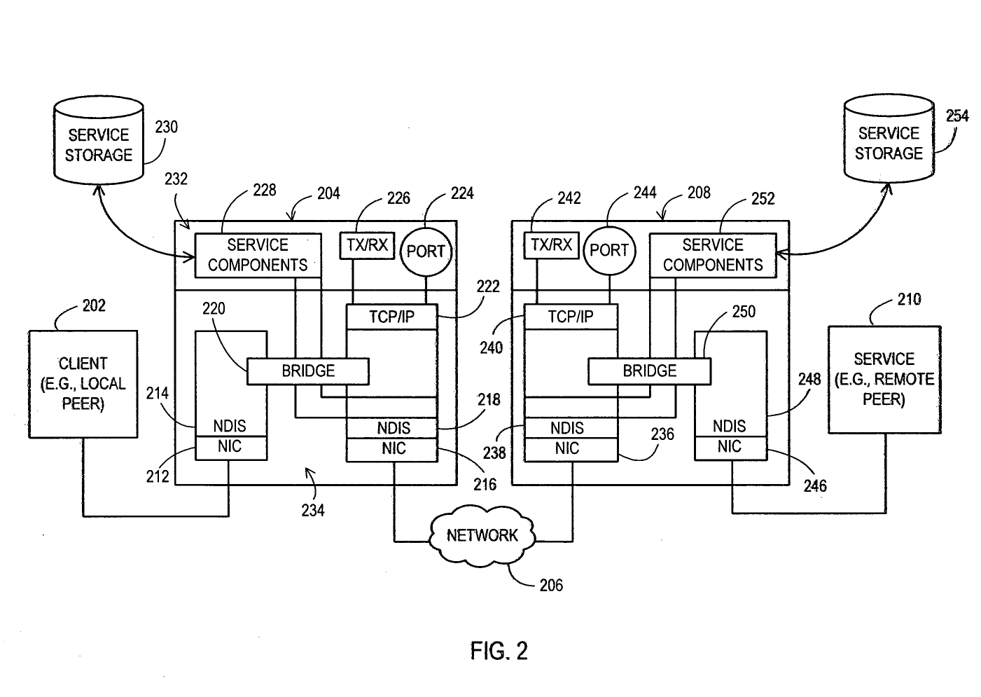

FIG. 2 shows an example where two complementary intermediate devices 204, 208 are present for providing a service for the data communications between a client device 202 and a service device 210. In the configuration shown, these two complementary intermediate devices 204, 208 are on opposite sides of a network 206 being used to transport communications between the client device 202 and the service device 210.

The first intermediate device 204 includes various components in this example that form a processing system. In this example, the processing system of the intermediate device 204 includes a kernel mode portion 234 and a user mode portion 232. The kernel mode portion 234 sends and receives packets via a first network interface card (NIC) 212 that provides a physical connection to the client 202 or to some intervening device such that data packets are exchanged between the client 202 and the intermediate device 204. A data link layer system 214 of the kernel portion 234, such as a network driver interface specification layer (NDIS) operates with the NIC 212 to pass the packets over a bridge 220 to the network and transport layers 222. The network and transport layers 222 of the kernel portion 234 may utilize protocols such as the Internet Protocol (IP) for the network layer and transmission control protocol (TCP) or user datagram protocol (UDP) for the associated transport layer. Other examples of the data link, network, and transport layers are also applicable to the various embodiments.

In this particular example, the device 204 is physically located in the data path between the client 202 and the network 206. Accordingly, the kernel mode portion 234 also sends and receives packets via a second NIC 216 and associated data link layer 218 that provide packets up to the network and transport layers 222. The NIC 216 exchanges packets over the network 206, such as a wide area network interconnecting the local network of the client 202 to the local network of the service 210.

The user mode portion 232 of intermediate device 204 forms a processing system that includes various components as well. These components may vary from one type of service being provided to another. A collection of service components 228 and service storage 230 are shown in this example. These service components 228 may include encryption logic, authentication logic, anti-virus logic, anti-spam logic, compression logic, and so forth. The service storage 230 may include information utilized by the service components 228 such as encryption keys, dictionaries for virus and/or spam checks, authentication information, dictionaries for compression, and so forth. The service storage may take the form of electronic, optical, magnetic or other memory devices.

Regardless of the service being provided, in this example there are also components that provide the ability for the intermediate device 204 to discover other devices and/or to be discovered by other devices. A transmission and reception engine 226 may be included in order to send and receive data packets through communication sessions in which the intermediate device 204 is participating. The engine 226 may utilize the transport and network layers 222 to send packets via the data link layer 218 and NIC 216 to establish communication sessions over the network 206.

In addition to the engine 226, a dedicated transport layer port 224 is utilized to discover other devices and/or to be discovered by other devices. In order to discover other intermediate devices, the engine 226 sends a probe packet at an appropriate time, as discussed below, on a specific transport layer port number which is referred to herein as the discovery network port. Port 224 of device 204 is the discovery network port for this device whereby the engine 226 listens on port 224 for all incoming packets addressed to this device to determine whether a connection request is being received from another intermediate device. This connection request may result from a probe packet being sent from this intermediate device in an attempt to discover another intermediate device and the return connection request to port 224 indicates that an intermediate device has been discovered.

Upon the device 204 being discovered, the device 204 may then enter into a communication session with another device, such as intermediate device 208. Through this communication session, the service may then be implemented on behalf of the client device 202 and service device 210. For example, the device 208 may perform a complementary service to the service of device 204, such that through the communication session these two devices 204, 208 may configure the service being provided by them. For example, these two devices 204, 208 may establish an encryption, a tunnel, a compression/decompression, and so forth.

Intermediate device 208 is a mirror image of intermediate device 204 in this example. Device 208 includes a kernel mode portion including a NIC 236 to interface to the network 206 and a NIC 246 to interface to the service device 210. Device 208 includes data link layers 238 and 248, the bridge 250, and the transport and network layers 240. A user mode portion includes a transmission/reception engine 242, a discovery network port 244 of the transport layer, service components 252, and service storage 254.

The intermediate devices 204 and 208 of FIG. 2 are shown for purposes of illustration and are not intended to be limiting. The particular configuration of components, kernel mode portions, user mode portions, presence of service components and storage, and so forth are for purposes of example and are not intended to be limiting to the contents of an intermediate device capable of being discovered according to the embodiments disclosed herein. Furthermore, while the intermediate devices 204 and 208 are shown as stand-alone structures, these devices may instead be incorporated into endpoints. For example, intermediate device 204 may be incorporated into the structure of the client device 202, thus eliminating the presence of the NIC 212.

The user mode processing system 232 and kernel mode processing system 234 of each device 204, 208 may be constructed of hard-wired logic, firmware, general-purpose programmable processors implementing programming stored in memory such as the storage device 230 or 254, and so forth. The devices of FIG. 2, including the intermediate devices 204, 208 as well as the client and service devices 202, 210 may include a variety of computer readable media. Such computer readable media contains the instructions for operation of the device and for implementation of the embodiments discussed herein. Computer readable media can be any available media that can be accessed by a computer system and includes both volatile and nonvolatile media, removable and non-removable media. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by a computer system.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

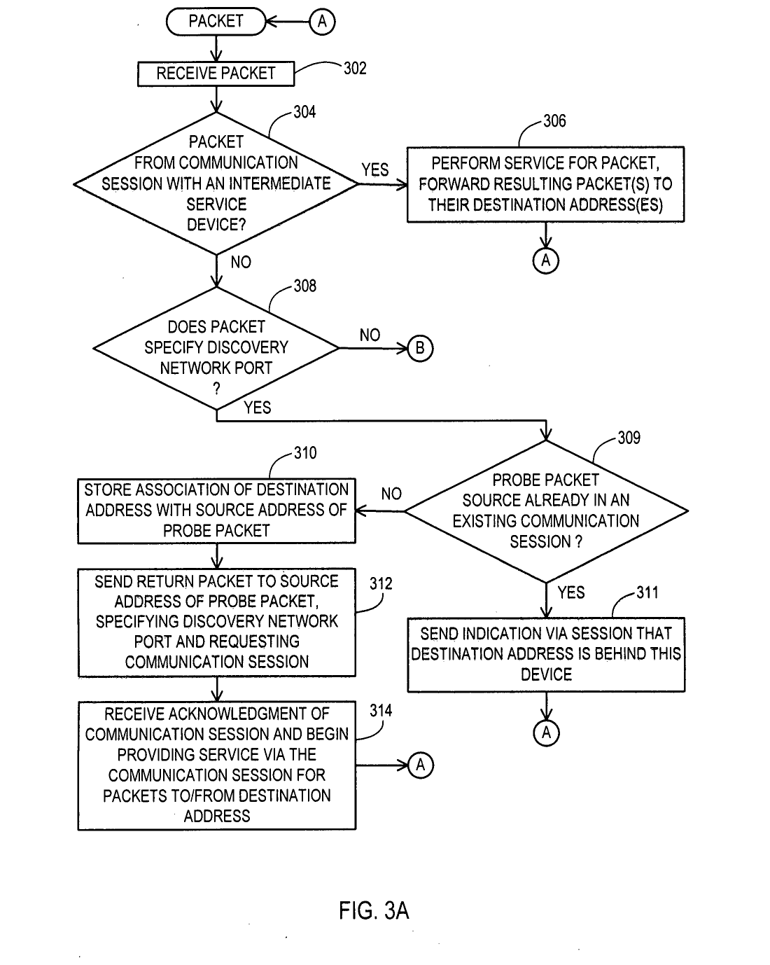

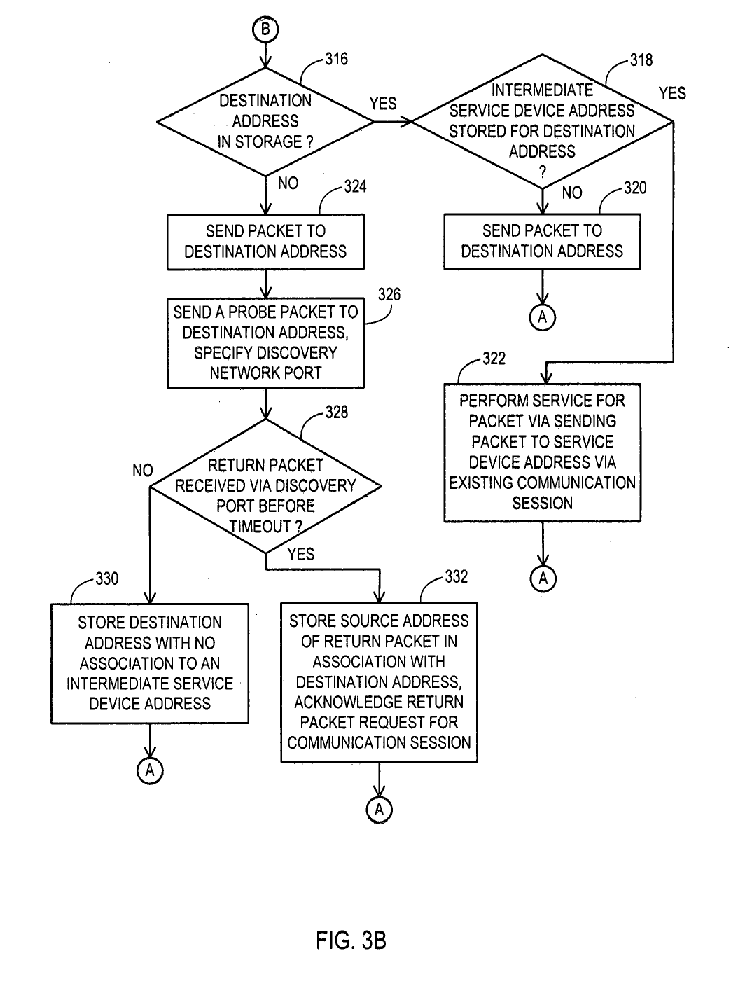

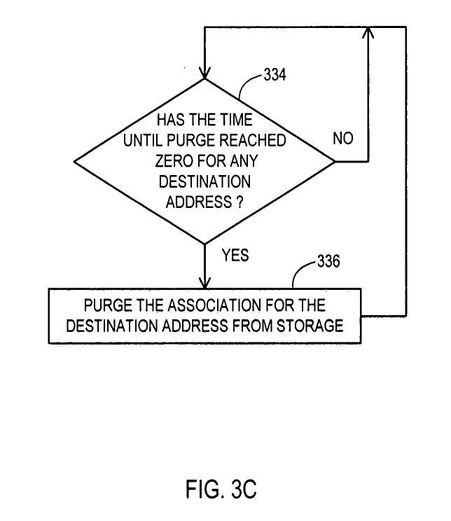

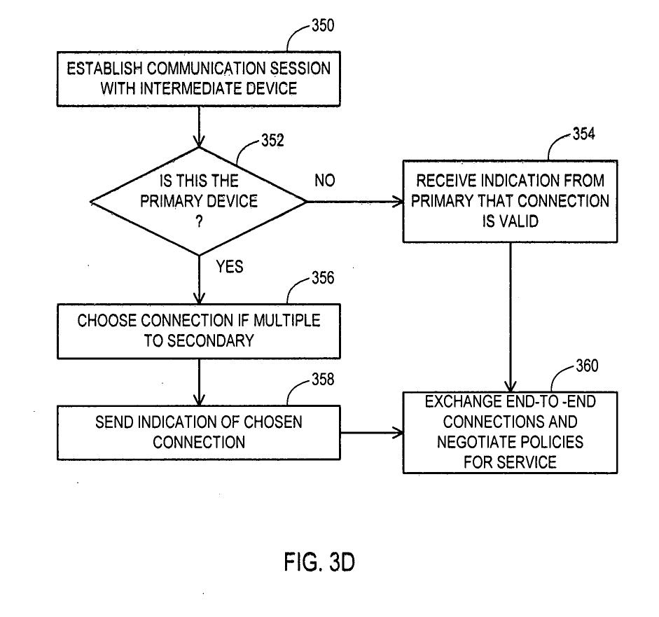

FIGS. 3A-3D show examples of logical operations performed by an intermediate device in order to discover another intermediate device and/or to be discovered. These logical operations are shown as an example of one implementation. However, it will be appreciated that there may be variations and that these logical operations shown in FIGS. 3A-3D are not intended to be limiting.

The logical operations begin in response to an incoming packet. The packet is received at reception operation 302. At query operation 304, this intermediate device detects whether the packet is from an existing communication session (e.g., an existing TCP, UDP, IPsec connection) with another intermediate service device.

If it is from an existing communication session, then this intermediate device performs whatever service is pertinent to the packet that has been received and forwards any resulting packets to their intended destination addresses at service operation 306. For example, this intermediate device may be receiving packets that are intended for the client device to which it is connected, and this intermediate device acts upon those packets and sends them on to the client device. This may involve analyzing the packet for a virus or spam signature, extracting the packet from the tunnel provided by the communication session with the other intermediate device, decompressing information of the incoming packet, and so forth. The device then awaits another packet.

If the packet is not from an existing communication session, then this intermediate device detects at query operation 308 whether the packet specifies the discovery network port as the destination port. Here, the kernel mode portion is always analyzing packets addressed to other devices in order to determine whether the destination port is the discovery network port and when it is, then intercepts the packet and relays information to the user mode portion about the source address. If the packet is not a probe packet via the discovery network port, then operational flow proceeds to query operation 316 of FIG. 3B which is discussed below. If the packet specifies the destination port as the discovery network port, then query operation 309 detects whether the probe packet that has been intercepted has a source address that corresponds to an existing communication session with another intermediate device. Furthermore, the probe packet may then be dropped and this connection of the probe packet to the destination address times out.

If the packet is from a source address of an existing communication session, then this indicates that there is a destination device behind this intermediate device that is unknown to the other intermediate device. Therefore, this intermediate device sends an indication via the existing communication session to the other intermediate device that the destination address is behind this intermediate device at send operation 311. This allows the other intermediate device to recognize that all future communications to that destination address may be communicated to this intermediate device via the service being provided by the intermediate devices through the existing communication session, such as encryption, tunneling, compression, and so forth using any already agreed upon policies.

If the probe packet is not from a source address that corresponds to an existing communication session with another intermediate device, then this is indicative of another intermediate device that has yet to discover this intermediate device and has reason to do so because the destination address is to a device behind this intermediate device. Therefore, this intermediate device stores an association of the destination address with the source address of the probe packet at store operation 310. This intermediate device then sends a return packet to the source address of the probe packet and specifies the discovery network port and requests that a communication session be established between them at send operation 312.

As an alternative to specifying the discovery network port for the return packet, the intermediate devices could be configured such that return packets are known to be returned on a different reserved port number. However, it may be desirable to utilize the discovery network port for return packets as well in order to preserve the number of available ports to other purposes.

After having sent the return packet, this intermediate device then receives an acknowledgement of the communication session at reception operation 314 and begins providing service via the communication session for packets to and from the destination address stored from the probe packet. Within the communication session, this intermediate device and the other intermediate device may agree upon policies utilized for providing whatever service they are offering.

Returning to query operation 316 of FIG. 3B, at this point it has been determined that a packet has been received outside of any existing communication session with another intermediate device and the packet is not a probe packet. For example, this may be a packet that is coming from the local client device to be sent over the network to a service device or this may be a packet coming in from the service device to be forwarded to the client device where no other intermediate device is involved. Query operation 316 detects whether the destination address of the packet is already in storage as a known destination address. If it a known address, then query operation 318 detects whether an intermediate device address is stored in association with this destination address. If not, then the packet may be forwarded on to the destination address at send operation 320. If it is associated with an intermediate device address, then this intermediate device performs whatever service it offers for the packet and sends it to the intermediate service device address via the existing communication session at service operation 322.

Where the destination address of the packet is not stored already, then this intermediate device has not dealt with a packet to this destination address since the lost purge, discussed below. Thus, this indicates that this intermediate device may need to discover another intermediate device where the device at the destination address may be behind another intermediate device and would benefit from service being provided by the intermediate devices. Therefore, operational flow proceeds to send operation 324 so that the packet is sent on to the destination address to avoid breaking the end-to-end connection, but operational flow further proceeds to send operation 326 for generation of a probe packet.

At send operation 326 this intermediate device sends a probe packet that specifies the discovery network port and sends it to the destination address of the packet. It is anticipated that the destination address is actually behind another intermediate device that is analyzing packets addressed to other devices to determine if the destination port is the discovery network port such that the packet addressed to the destination address will reach the other intermediate device which will intercept it by detecting that the destination port is the discovery network port. One example of a probe packet is a TCP packet with the SYN flag set.

At query operation 328, this intermediate device detects whether a return packet has been received in response to the probe packet before a timeout occurs. The timeout may be a customary transport layer timeout period although in this example, the return packet may be a different connection than the probe packet since the probe packet was addressed to the destination address behind the other intermediate device rather then to the intermediate device. In this example, this intermediate device listens for the return packet via the discovery network port, or alternatively another reserved network port established for return packets, so that the return packet can easily be recognized as a packet from a responding other intermediate device rather than a packet being received from some device unrelated to the probe packet that has been sent. The return packet may be another TCP packet with the SYN flag set or a packet of another protocol such as UDP or raw IP that requests a connection to thereby establish a new connection between the two intermediate devices.

Where no return packet has been received before the timeout, then this intermediate device stores the destination address with no association to another intermediate device address at store operation 330. Thus, for subsequent packets with this destination address, this intermediate device will send those on to the destination address as discussed above in relation to send operation 320.

Where the return packet has been received before the timeout, then this intermediate device stores the source address of the return packet, which is the network address of the other intermediate device, in association with the destination address and sends an acknowledgement of the request for a communication session to the other intermediate device at acknowledgement operation 332. An example of the acknowledgement would by a TCP packet with the SYN and ACK flags set. This intermediate device may then begin providing service via the communication session for packets to and from the destination address stored from the probe packet. Within the communication session, this intermediate device and the other intermediate device may agree upon policies utilized for providing whatever service they are offering.

FIG. 3C shows an example of a background purge process that may be performed by this intermediate device in order to maintain an updated configuration for end-to-end device connections and to reduce memory usage. This intermediate device may detect whether the time until purge for a given destination address that is stored in memory has reached zero at query operation 334. This query operation 334 may recur to continuously check for destination addresses in memory that should be purged. Upon detecting that the time to purge has been reached, then this intermediate device purges the association for the destination address from storage at purge operation 336.

The purge process of FIG. 3C may help maintain an updated configuration for this intermediate device because by purging the association, the intermediate device will be forced to re-evaluate whether an intermediate device has been added or removed in relation to the destination address being purged. For example, if a destination address with a null association later has a complementary intermediate device added in front of it, this intermediate device may continue to communicate packets directly to the destination address since it has no knowledge of the new intermediate device. However, upon the time to purge being reached, this intermediate device will initiate a probe packet to the destination address that has been purged and will then discover the new intermediate device.

Furthermore, the process of FIG. 3C may reduce the amount of storage in memory by purging destination addresses. Since maintaining a list of all destination addresses that are seen during the operating period of this intermediate device could require an impractical amount of storage, purging old ones frees storage space. Any address association that is purged will be added back once communications to that destination address are again seen so operability with that destination address is not lost due to the purge.

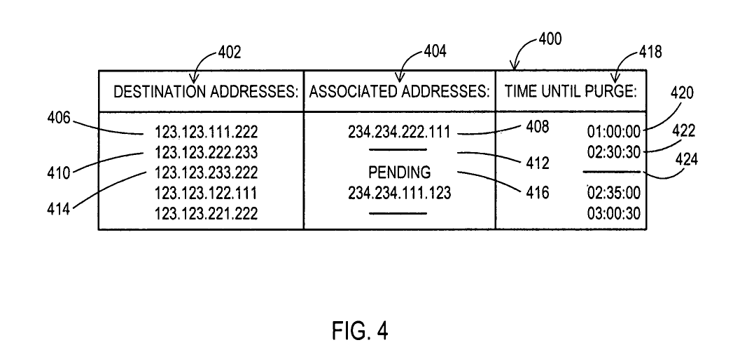

FIG. 4 shows an example of a table 400 in memory that maintains the destination address associations. Column 402 contains the list of destination addresses for the end-to-end connections between the client and service devices. Column 404 includes the list of associated addresses which are the addresses of the other intermediate devices that are in front of the associated destination addresses. Column 418 specifies the purge timer value for each destination address association that is stored.

Column 404 may have various data values. One data value may be an actual network address of the intermediate device. Another data value may be a null value where there is no intermediate device associated with a particular destination address. Another data value may represent a pending status where this intermediate device is in the process of determining whether there is an intermediate device address to be associated with a particular destination address.

In the example shown, the destination address of entry 406 is associated with the intermediate device address of entry 408 which has a time to purge entry 420. The destination address of entry 410 is associated with a null value of entry 412, indicative of the absence of a complementary intermediate device in front of this destination address, which has a time to purge entry 422. The destination address of entry 414 is associated with the pending status of entry 416 which has a null time to purge entry 424 since the pending status will resolve itself and not require a purge.

Returning to FIG. 3D, an embodiment of this intermediate device may further implement these logical operations in order to resolve race conditions and to reduce the number of discovery attempts that are necessary. In this example, these logical operations begin by this intermediate device establishing a communication session with another intermediate communication device at session operation 350. Session operation 350 is representative of the creation of the communication session that has occurred at reception operation 314 and acknowledgement operation 332 of FIGS. 3A and 3B, respectively.

Upon one or more communication sessions being established between this intermediate device and another one, this intermediate device and the other one detects which is the primary device at query operation 352. This detection may occur in one of various ways. The devices may negotiate which device is the primary one based on such factors as current load, number of associations stored, number of connections for which each is already a primary, and so forth. One example of detecting whether this intermediate device is a primary is to compare its network address to the network address of the other intermediate device. This device may consider each network address to be a large integer value. The convention may then be that the device with the larger integer value is the primary one. Of course, the opposite convention could be used as well.

If this intermediate device is not the primary one, then it eventually receives an indication from the other one, which is the primary, that a particular connection is valid at reception operation 354. This intermediate device may terminate any other session that it has with this primary intermediate device. This intermediate device then begins exchanging its end-to-end connections with the primary intermediate device at exchange operation 360, and policies for providing service for each of those end-to-end connections that are common to this intermediate device and the primary intermediate device can be negotiated.

Exchanging the end-to-end connections allows the two intermediate devices of this communication session to determine which of these end-to-end (i.e., client device to server device) connections of the other intermediate device are being serviced by it. The destination addresses of these common end-to-end connections can then be stored in the table, such as in FIG. 4, with the association to the other intermediate device such that the discovery process is skipped whenever these destination addresses are encountered. The exchange may occur by having the primary intermediate device send its list first while the secondary device waits for it and then responds to it with its own list. Of course, the opposite convention could be utilized instead whereby the secondary device sends its list first and then the primary responds by sending its own list.

Returning to query operation 352, if this intermediate device is the primary one, then this intermediate device chooses the connection to maintain in this example, should there be multiple communication sessions established with the other intermediate device, at connection operation 356. Multiple communication sessions may occur due to simultaneous creation resulting from a race condition whereby each intermediate device is sending a probe packet to the other one at the same time. By having a convention for determining a primary intermediate device and a secondary intermediate device and for assigning duties for selecting the appropriate connection to maintain, such race conditions can be resolved.

The connection to be maintained may be chosen through one of various conventions. For example, the primary intermediate device may choose the connection that was fully established first. The primary intermediate device may instead choose the connection that it initiated or may even arbitrarily choose the connection. This primary intermediate device sends the indication of the chosen connection to the other intermediate device at send operation 358, and then both devices may allow the unused connection to timeout and terminate. Then operational flow proceeds to exchange operation 360 for purposes of exchanging the end-to-end connections as discussed above.

The discussion of FIG. 3 which is in relation to a configuration such as that shown in FIG. 2 where two intermediate devices are logically between the client device and service device, is provided for purposes of illustration and is not intended to be limiting. These logical operations illustrate how intermediate devices may discover other intermediate devices and how they can be discovered. However, other devices including endpoint devices such as the client device and the service device may also discover intermediate devices by implementing operations to send probe packets that are addressed to a destination address beyond the intermediate device and that specify the discovery network port. In turn, the intermediate device analyzes packets and intercepts them if the destination port is the discovery network port and will send a return packet back to the device that has sent to the probe packet regardless of whether the probe packet was sent from another intermediate device or an endpoint device.

Although the subject matter above has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method of discovering an intermediate device of a computer network that is logically located between a client device and a service device, comprising:
receiving at the intermediate device incoming packets including a probe packet that specifies a destination network address of the service device, that specifies a source network address, and that specifies a discovery network port;
determining at the intermediate device whether incoming packets that specify the destination network address of the service device also specify a discovery network port; and
in response to determining that the probe packet specifies the discovery network port, sending from the intermediate device a return packet that specifies as the destination address the source network address of the probe packet and that specifies the source network address of the return packet as that of the intermediate device.

2. The method of claim 1, further comprising sending the probe packet from the client device.

3. The method of claim 1, further comprising sending the probe packet from a second intermediate device that is logically located between the client device and the service device.

4. The method of claim 1, further comprising establishing a communication session between a device that sent the probe packet and the intermediate device upon receipt of the return packet by the device that sent the probe packet.

5. The method of claim 4, further comprising providing a service to the client device upon establishing the communication session between the device that sent the probe packet and the intermediate device.

6. The method of claim 5, further comprising:
prior to sending the probe packet, receiving at the device that sends the probe packet a data packet with the destination address of the service device;
detecting whether the destination address of the service device is recognized from a store of previous packet destination addresses; and
in response to detecting that the destination address of the service device is not recognized, then sending the probe packet.

7. The method of claim 6, further comprising:
storing the destination address of the service device in the store of previous packet destination addresses; and
storing an association of the network address of the intermediate device to the network address of the service device.

8. The method of claim 7, further comprising:
periodically purging the destination address of the service device from the store.

9. A computer readable medium containing instructions encoded thereon that when implemented perform acts comprising:
sending a probe packet to a destination address, the probe packet specifying a discovery network port and specifying the network address of the sending device as the source address;
detecting whether a return packet is received from a device that specifies a source address different than the destination address within a pre-defined period of time; and
upon detecting that the return packet that specifies the source address different than the destination address is received within the pre-defined period of time, then establishing a communication session with a device at the source address of the return packet.

10. The computer readable medium of claim 9, wherein the acts further comprise:
prior to sending the probe packet:
detecting a data packet to be sent that has the destination address; and
detecting whether the destination address is not stored within a store of previous packet destination addresses; and
when the destination address is not stored within the store of previous packet destination addresses, then sending the probe packet.

11. The computer readable medium of claim 10, wherein the acts further comprise sending to the destination address the data packet that has the destination address.

12. The computer readable medium of claim 10, wherein the acts further comprise:
upon detecting that the return packet is not received within the pre-defined period of time, then sending to the destination address the subsequent packets addressed to the destination address.

13. The computer readable medium of claim 9, wherein the acts further comprise storing an association of the destination address with the source address of the return packet.

14. The computer readable medium of claim 13, wherein the acts further comprise:
subsequent to establishing the communication session, detecting a packet to be sent to the destination address;
communicating via the communication session with the device that sent the return packet to provide a service relative to the data packet addressed to the destination address.

15. The computer readable medium of claim 10, wherein the acts further comprise:
detecting a data packet to be sent that has a different destination address; and
detecting whether the different destination address is not stored within a store of previous packet destination addresses; and
when the different destination address is not stored within the store of previous packet destination addresses, then sending a second probe packet to the different destination address, the probe packet specifying the discovery network port and specifying the network address of the sending device as the source address;
detecting whether a different return packet is received from a device that specifies a source address different than the different destination address within a pre-defined period of time;
detecting whether information is received via the communication session regarding the different destination address;
upon detecting that the different return packet that specifies the source address different than the destination address is received within the pre-defined period of time, then establishing a different communication session with a device at the different source address; and
upon detecting that information is received via the communication session regarding the different destination address, then storing an association of the different destination address to the source address of the device of the communication session.

16. A device that allows for automatic discovery in a network, comprising:
a memory;
at least one network connection;
a processing system that:
sends and receives data packets through the at least one network connection,
sends a probe packet through one of the at least one network connections in response to receiving a packet addressed to a destination address that is not in memory, the probe packet specifying the destination address and a discovery port,
detects whether a return packet is received within a pre-defined timeout period through one of the at least one network connections and if so, then stores in memory a source address of the return packet in association with the destination address,
analyzes a different probe packet received through one of the at least one network connections to determine whether a destination port of the different probe packet is the discovery port, and
sends a return packet to a source address of the different probe packet, the return packet specifying the network address of the device as the source address.

17. The device of claim 16, wherein the processing system establishes a communication session with a device that sent the return packet and establishes a different communication session with a device that sent the probe packet.

18. The device of claim 17, wherein the processing system receives a different probe packet with a different destination address that specifies the discovery port, looks up the source address in memory to detect whether a communication session is established with the source address, and when the communication session is established with the source address, then responding via the communication session with the source address to indicate that the different destination address is behind the network address of the device.

19. The device of claim 17, wherein the processing system sends a second different probe packet addressed to a second different destination address that specifies the discovery port, detects that information regarding the second different destination address is received through one of the established communication sessions, and stores the second different destination address in association with the network address of the established communication session.

20. The device of claim 17, wherein the processing system provides services for data communications to and from the destination addresses by communicating information over the established communication sessions.
